(19) United States
(12) Patent Application Publication
(10) Pub. No.: US 2009/0289880 A1
(43) Pub. Date: Nov. 26, 2009

(54) DISPLAY DEVICE AND BOTTOM CHASSIS THEREOF

(75) Inventors: Dae Hyoun BYOUN, Seoul (KR); Seung Bum KIM, Seoul (KR); Jan Seok AN, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/372,012

(22) Filed: Feb. 17, 2009

(30) Foreign Application Priority Data
May 21, 2008 (KR) 2008-46923

(51) Int. Cl. G09G 3/36

(52) U.S. Cl. 345/87

(57) ABSTRACT

A display device, which has a bottom chassis provided with an opening formed at one side thereof and receiving light sources therein, and at least one optical member connected to the opening to enhance optical characteristics of light emitted from the light sources, includes an optical member fixing unit including integral supporters formed integrally with the bottom chassis; and separable supporters connected to the bottom chassis to prevent movement of the at least one optical member connected to the integral supporters. The display device allows the separable supporters to have a smaller size than that of a conventional middle bezel, thus reducing production costs and to easily assemble the at least one optical member to the bottom chassis.

### CROSS-REFERENCE TO RELATED APPLICATIONS

This application claims priority under 35 U.S.C. §119(a) from Korean Patent Application No. 2008-0046923, filed May 21, 2008, in the Korean Intellectual Property Office, the disclosure of which is incorporated herein in its entirety by reference.

### BACKGROUND OF THE INVENTION

1. Field of the Invention

The present general inventive concept relates to a display device and a bottom chassis thereof, and more particularly, to a display device, in which separable supporters have a smaller size than that of a conventional middle bezel to reduce production costs and optical members are easily assembled with a bottom chassis compared with a case of using a separate middle bezel, and a bottom chassis thereof.

2. Description of the Related Art

In general, display devices, which are widely used, are divided into an emissive type and a non-emissive or passive type. Emissive-type display devices refers to display devices, which can emit light by themselves, and include a plasma display panel (PDP), and non-emissive display devices refers to display devices, which cannot emit light by themselves, and include a liquid crystal display (LCD).

Each of the above display devices includes front and rear covers forming an external appearance of the device, and a display module contained in front and rear covers and forming an image.

The display module includes a bottom chassis housing light sources, and optical members for enhancing optical characteristics of light emitted from the light sources are connected to an opening of the bottom chassis by a middle bezel.

The bottom chassis is generally made of a metal, and a reflection plate is provided in the bottom chassis. The reflection plate made of a high reflective material is provided on the bottom chassis, and thus light emitted backwardly from the light sources is reflected by the reflection plate and travels toward the opening of the front surface of the bottom chassis.

The optical members enhance optical characteristics of light emitted from the light sources. Since the light sources are generally line light sources, upper portions of the light sources are light and other portions of the light sources are dark. The optical members reduce a difference between light and darkness using dispersion of light, and thus enhance brightness uniformity.

The middle bezel is a rectangular frame, which is provided separately from the bottom chassis or the optical members. A worker locates a plurality of optical members playing different roles at an opening of the bottom chassis, and then connects the middle bezel to the bottom chassis. As the middle bezel having a shape of a rectangular frame is connected to the bottom chassis, the middle bezel presses rectangular edges of the optical members, and then the optical members are fixed to a correct position by the pressing force.

However, in the conventional display device and the bottom chassis thereof, the middle bezel connected to the bottom chassis has the shape of a rectangular frame, and thus increases production costs of the display device and the bottom chassis thereof. Further, since the optical members are fixed using the middle bezel after the optical members are located to the connection portion of the bottom chassis, assembling the conventional display device and the bottom chassis thereof is not easy.

### SUMMARY OF THE INVENTION

The present general inventive concept provides a display device, which includes separable supporters having a smaller size than that of a conventional middle bezel to reduce production costs and to easily assemble optical members to a bottom chassis, and a bottom chassis thereof.

The present general inventive concept also provides a display device to prevent a difference between light and darkness on optical members due to lightening only specific regions of optical members by light reflected by an optical member fixing unit, and a bottom chassis thereof.

The present general inventive concept also provides a bottom chassis, which has excellent physical characteristics, such as a thermal expansion rate, strength, and a injection molding property.

Additional aspects and utilities of the present general inventive concept will be set forth in part in the description which follows and, in part, will be obvious from the description, or may be learned by practice of the general inventive concept.

The foregoing and/or other aspects and utilities of the general inventive concept may be achieved by providing a display device, which has a bottom chassis provided with an opening formed at one side thereof and receiving light sources therein, and at least one optical member connected to the opening to enhance optical characteristics of light emitted from the light sources, including an optical member fixing unit including integral supporters formed integrally with the bottom chassis, and separable supporters connected to the bottom chassis to prevent movement of the at least one optical member connected to the integral supporters.

The optical member fixing unit may further include position guides protruding from the bottom chassis to guide the at least one optical member to a correct position.

Each of the position guides may include a base part contacting an edge of the at least one optical member on a condition that the at least one optical member has been connected to the bottom chassis, and an extension part extended from the base part and contacting the edge of the at least one optical member in a process of connecting the at least one member to the bottom chassis.

The position guides may be provided at both ends of each of the integral supporters.

The integral supporters may be provided on at least one edge of the bottom chassis, and each of the integral supporters may include a first rib protruding along the at least one edge to a height of an overall thickness or more of the at least one optical member, and a second rib bent from the first rib toward an inside of the bottom chassis.

The separable supporters may be connected to the bottom chassis such that the separable supporters cannot interfere with the integral supporters, and each of the separable supporters may include third ribs connected to the bottom chassis and a fourth rib bent from ends of the third ribs to press the at least one optical member.

At least one connection protrusion is provided on the bottom chassis, and a connection hole, into which the at least one connection protrusion is inserted, is formed on the third ribs.

The optical member fixing unit has a reflection suppressing structure to prevent a difference between light and darkness generated on the at least one optical member due to reflection of the light.

The reflection suppressing structure may be a reflection angle changing part to change a refraction direction of the light to reflect the light, being incident toward the optical member fixing unit, toward an inside of the optical member fixing unit.

The reflection suppressing structure may be a light absorption member to absorb the light being incident toward an inside of the optical member fixing unit.

The reflection suppressing structure may be a reflection protrusion to reflect the light such that the light cannot be incident toward an inside of the optical member fixing unit.

The foregoing and/or other aspects and utilities of the general inventive concept may also be achieved by providing a display device including a bottom chassis provided with an opening formed at one side thereof, to receive light sources therein, and made of a light reflective material to guide light emitted from the light sources toward the opening, at least one optical member connected to the opening to enhance optical characteristics of the light emitted from the light sources, and an optical member fixing unit including integral supporters formed integrally with the bottom chassis, and separable supporters connected to the bottom chassis to prevent movement of the at least one optical member connected to the integral supporters.

The light reflective material is polycarbonate (PC) containing 10˜30% of glass fiber.

The optical member fixing unit may further include position guides protruding from the bottom chassis to guide the at least one optical member to a correct position.

The optical member fixing unit has a reflection suppressing structure to prevent a difference between light and darkness generated on the at least one optical member due to reflection of the light.

The foregoing and/or other aspects and utilities of the general inventive concept may also be achieved by providing a display device a bottom chassis including integral supporters disposed at top and bottom portions thereof to receive optical members therein, and separable supporters connectable to opposite sides of the bottom chassis to support the optical members to be fixed to the bottom chassis.

The optical members may include a light converging sheet and a diffusion plate.

The separable supporters may include a first set of ribs and a second set of ribs extending in an outward direction from the first set of ribs.

The integral supporters may include position guides to guide the optical members, and ribs having a distance therebetween, wherein a width of the optical members and the distance between the ribs are different.

The foregoing and/or other aspects and utilities of the general inventive concept may also be achieved by providing a display device including optical members having connection protrusions, and a bottom chassis having separable supporters, the separable supporters having connection holes to engage the respective connection protrusions of the optical members and ribs to prevent movement from the optical members.

### BRIEF DESCRIPTION OF THE DRAWINGS

These and/or other aspects and utilities of the present general inventive concept will become apparent and more readily appreciated from the following description of the embodiments, taken in conjunction with the accompanying drawings in which:

FIG. 1 is an exploded perspective view illustrating a display device in accordance with an embodiment of the present general inventive concept;

FIG. 2 is a perspective view illustrating a bottom chassis of FIG. 1, taken along the line I-I;

FIG. 3 is an enlarged view illustrating a portion ‘A’ of a separable supporter of FIG. 1;

FIG. 4 is a perspective view illustrating a connection of optical members to the bottom chassis of FIG. 1;

FIGS. 5A to 5C are side views illustrating a connection of the optical members to the bottom chassis of FIG. 1;

FIG. 6 is a perspective view illustrating a connection of separable supporters to the bottom chassis;

FIGS. 7A and 7B are views illustrating routes of light emitted from a light source, respectively;

FIG. 8 is a view illustrating a route of light emitted from a light source in a display device in accordance with an embodiment of the present general inventive concept; and

FIG. 9 is a view illustrating a route of light emitted from a light source in a display device in accordance with an embodiment of the present general inventive concept.

### DETAILED DESCRIPTION OF THE PREFERRED EMBODIMENTS

Reference will now be made in detail to embodiments of the present general inventive concept, an example of which is illustrated in the accompanying drawings, wherein like reference numerals refer to like elements throughout. The embodiments are described below to explain the present general inventive concept by referring to the annexed drawings.

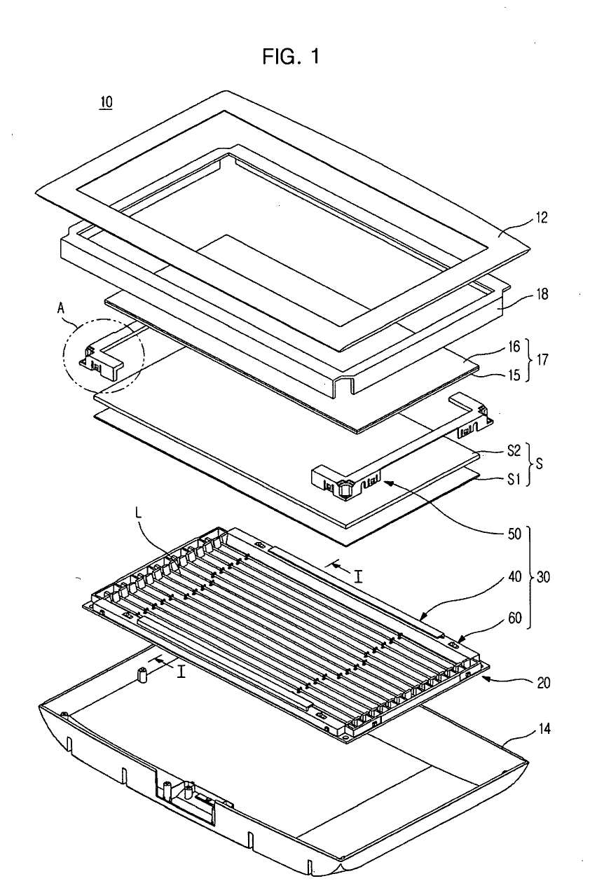

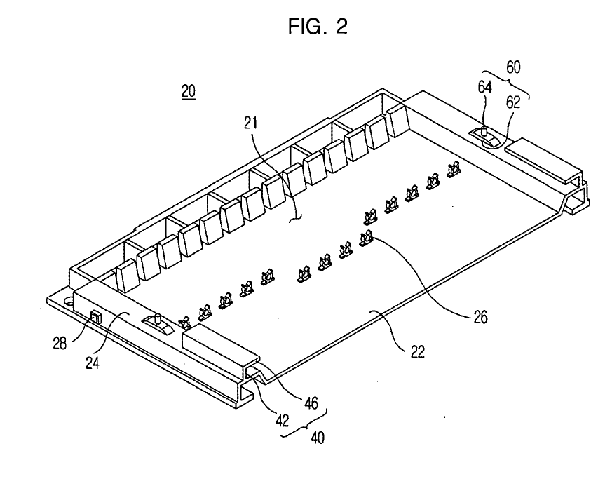

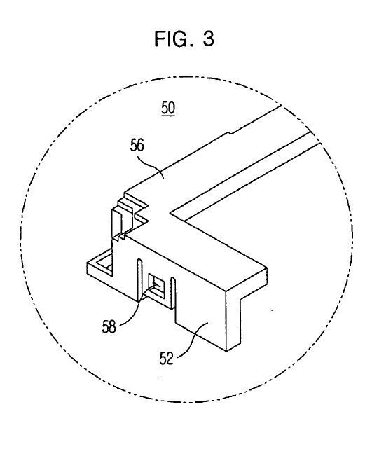

FIG. 1 is an exploded perspective view illustrating a display device in accordance with an embodiment of the present general inventive concept, FIG. 2 is a perspective view illustrating a bottom chassis of FIG. 1, taken along the line I-I, and FIG. 3 is an enlarged view of a portion ‘A’ of a separable supporter of FIG. 1.

As illustrated in FIGS. 1 to 3, a display device 10 in accordance with the embodiment illustrated in FIG. 1 includes front and rear covers 12 and 14, a display panel 17, a top chassis 18, a bottom chassis 20, optical members S connected to an opening 21 of the bottom chassis 20, and an optical member fixing unit 30.

The front and rear covers 12 and 14 form an external appearance of the display device 10. The front and rear covers 12 and 14 are made of a plastic resin. Various ornaments (not illustrated) to provide an esthetic appearance to a user are added to the front cover 12, and heat emission holes (not illustrated) to emit heat generated from the display device 10 are formed through the rear cover 14.

The display panel 17 displays an image using liquid crystal. The display panel 17 includes a thin film transistor (TFT) substrate 15, a color filter substrate 16 provided corresponding to the TFT substrate 15, and a liquid crystal layer (not illustrated) provided between the TFT substrate 15 and the color filter substrate 16. The display panel 17 is fixed to the top chassis 18.

The top chassis 18 connects the display panel 17 to the bottom chassis 20. That is, while the display device 10 is assembled, the display panel 17 is located on an upper surface of the bottom chassis 20 and the top chassis 18 is connected to the bottom chassis 20. When the top chassis 18 is connected to the bottom chassis 20, the top chassis 18 presses an edge of the display panel onto the bottom chassis 20, and thus a position of the display panel 17 is fixed.

The bottom chassis 20 houses light sources L installed therein. Here, plural light sources L are disposed on a body 22 of the bottom chassis 20 at regular intervals in parallel with one another. Cold cathode fluorescent lamps (CCFLs) or light emitting diodes (LEDs) may be used as the light sources L. Further, the light sources L may be an edge light type as well as a direct light type, as illustrated in the drawings. The light sources L are supported by lamp supporters 26, which are formed integrally with the bottom chassis 20. A conventional bottom chassis is generally made of a metal. The bottom chassis made of a metal has excellent physical characteristics, such as strength, but is heavy and expensive. In order to solve these drawbacks, the bottom chassis 20 is obtained by molding using polycarbonate (PC). PC is light and inexpensive, but has a low strength. Thus, the bottom chassis 20 is obtained by molding using PC containing glass fiber. When the bottom chassis 20 contains glass fiber, a strength of the bottom chassis 20 is increased. Specifically, when a weight of 5 kg is applied to a center of the bottom chassis 20, in a case that the bottom chassis 20 is obtained by molding using only PC, the bottom chassis 20 sags by an amount as long as 12.43 mm. Alternatively, in a case that the bottom chassis 20 is obtained by molding using PC containing 10% of glass fiber, the bottom chassis 20 sags by an amount as long as 9.12 mm, and in a case that the bottom chassis 20 is obtained by molding using PC containing 15% of glass fiber, the bottom chassis 20 sags by an amount as long as 7.5 mm. Further, in a case that the bottom chassis 20 is obtained by molding using PC containing 20% or more of glass fiber, the bottom chassis 20 has a high strength to reduce a generation of sagging, but has a high brittleness to be easily destructed even by a small deformation. Thus, in a case that the bottom chassis 20 is obtained by molding using PC containing 10˜20% of glass fiber, the bottom chassis 20 has excellent physical characteristics. Further, a thermal expansion rate of the bottom chassis 20, obtained by molding using PC containing 15% of glass fiber, is higher than that of the bottom chassis 20, obtained by molding using only PC, by 2.5 times or more. Accordingly, reducing generation of noise caused by friction of the lamp supporters 26 with the light sources L while the lamp supporters 26 are thermally deformed is possible. In the present embodiment, the lamp supporters 26 are integrally formed with the bottom chassis 20, PC is a light reflective material having an excellent reflection property. The bottom chassis 20, which is obtained by molding mainly using PC, reflects a portion of light emitted from the light sources L, which travels toward the body 22 in an opposite direction of the opening 21, to the opening 21, and thus serves as a reflection plate. Thus, the bottom chassis 20 does not require any separate reflection plate attached thereto, and reduces production costs through simplification of a manufacturing process. The optical members S are provided in the opening 21.

The optical members S enhance optical characteristics of light emitted from the light sources L such that the light is uniformly irradiated onto the display panel 17. The optical members S can include plural optical members S1 and S2 which play differing roles. That is, the optical members S include a diffusion plate S1, which diffuses the light emitted from the light sources L to reduce a brightness difference, and a light converging sheet S2, which changes an optical route such that the light emitted from the light sources L is perpendicular to the display panel 17. Although the drawings illustrate the optical members S including the diffusion plate S1 and the light converging sheet S2 for the convenience of illustration, a type or number of the optical members S is not limited thereto. The optical members S are connected to the bottom chassis 20 by the optical member fixing unit 30.

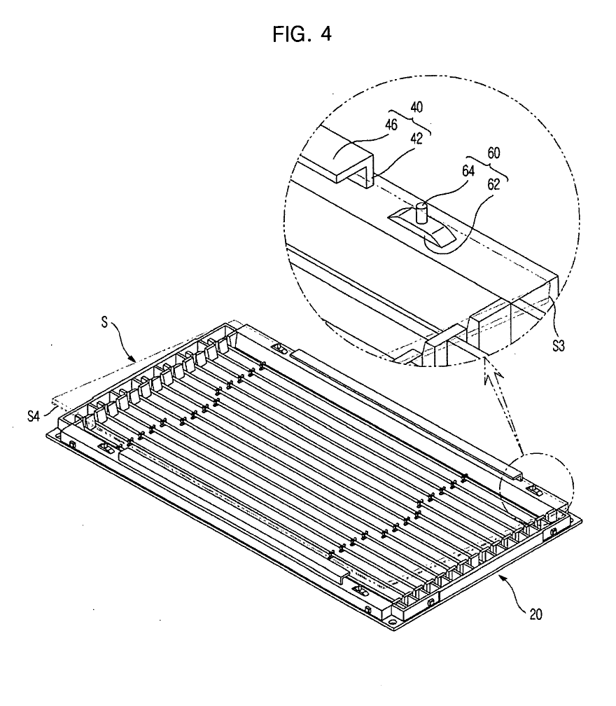

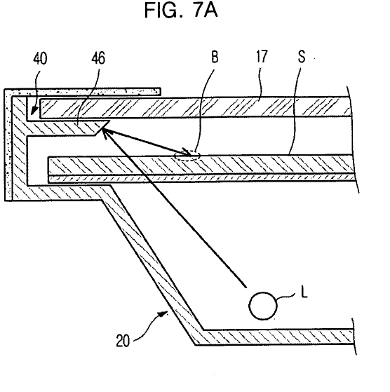

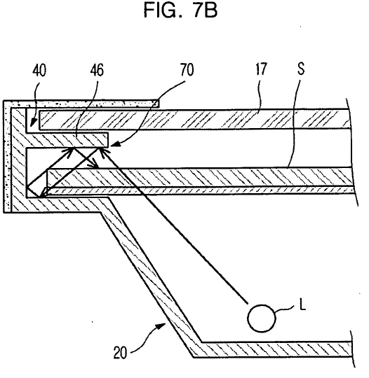

The optical member fixing unit 30 is formed integrally with the bottom chassis 20 or is formed separately from the bottom chassis 20, and thus serves to connect the optical members S to the bottom chassis 20. Here, since some structures of the optical member fixing unit 30 are formed integrally with the bottom chassis 20, production costs can be reduced. Other structures of the optical member fixing unit 30, which are formed separately from the bottom chassis 20, have a smaller size than that of a conventional middle bezel, and thus production costs can be reduced. The optical members S are easily connected to the bottom chassis 20 by inserting edges (S3 and S4 of FIG. 4) of the optical members S into the optical member fixing unit 30. Further, the optical member fixing unit 30 guides the optical members S to a correct position, such that the optical members S can be easily fixed to the bottom chassis 20. A reflection suppressing structure (70 of FIG. 7B), which will be described in detail later, can be provided on the optical member fixing unit 30 to prevent a brightening of only specific regions of the optical members S due to the reflection of light emitted from the light sources L by the optical member fixing unit 30. The optical member fixing unit 30 includes integral supporters 40, separable supporters 50, and position guides 60.

The integral supporters 40 are formed on a bottom chassis edge portion 24 such that the optical members S are inserted into the integral supporters 40. That is, the integral supporters 40 having a corresponding shape are formed on both lengthwise sides of the rectangular bottom chassis 20, such that the integral supporters 40 can be formed integrally with the body 22. Since the integral supporters 40 are formed integrally with the bottom chassis 20, the bottom chassis 20 has low production costs compared with a bottom chassis, from which supporters are formed separately. The optical members S are received within insides of the integral supporters 40 by inserting the first optical member edge (S3 of FIG. 4) into any one of the integral supporters 40 and then inserting the second optical member edge (S4 of FIG. 4), being opposed to the first optical member edge (S3 of FIG. 4), into an other one of the integral supporters 40. Differing from the conventional bottom chassis, the optical members S are connected to the bottom chassis 20 by respectively inserting both edges of the optical members S into the integral supporters 40, and thus the optical members S can be easily assembled with the bottom chassis 20. Each of the integral supporters 40 includes a first rib 42 provided on the bottom chassis edge portion 24, and a second rib 46 bent from the first rib 42.

The first rib 42 protrudes from the bottom chassis edge portion 24 to a height of an overall thickness or more of the optical members S. The height of the first rib 42 is varied according to the connecting methods of the optical members S. That is, in a case that the optical members S are connected to the integral supporters 40 by sliding the optical members S from the side surfaces of the integral supporters 40, the first ribs 42 of the integral supporters 40 protrude to a height similar to the overall thickness of the optical members S. Alternatively, in a case that the optical members S are connected to the integral supporters 40 by inserting one of the first and second optical member edges (S3 and S4 of FIG. 4) into any one of the integral supporters 40 and then inserting the other one of the first and second optical member edges (S3 and S4 of FIG. 4) into the other one of the integral supporters 40, a designated space is required for the insertion process, and thus the first ribs 42 of the integral supporters 40 protrude to a height greater than the overall thickness of the optical members S.

The second ribs 46 of the integral supporters 20 are respectively bent from the first ribs 42 toward the inside of the body 22. Although a small gap is formed between the optical members S and the second ribs 46, the optical members S are substantially supported by the second ribs 46.

The separable supporters 50 are connected to the body 22 of the bottom chassis 20 to prevent the movement of the optical members S. Since the integral supporters 40 are prepared in a pair to correspond to both lengthwise sides of the bottom chassis 20, both widthwise sides of the optical members S are not supported even when the optical members S are inserted into the integral supporters 40. Further, since the small gap is formed between the optical members S and the second ribs 46 of the integral supporters 40, as described above, the optical members 46 cannot be completely supported only by the integral supporters 40. The separable supporters 50 are connected to both sides of the bottom chassis 20, and thus allow the optical members S to be fixed to the bottom chassis 20. The separable supporters 50 are connected to the widthwise sides and portions of the lengthwise sides of the bottom chassis 20 by an amount so that the separable supporters 50 do not interfere with the integral supporters 40 provided on the lengthwise sides of the bottom chassis 20, and thus have a smaller size than that of a conventional middle bezel having a shape of a rectangular frame, thereby reducing production costs of the bottom chassis 20. Each of the separable supporters 50 includes third ribs 52 connected to the body 22, and a fourth rib 56 bent from ends of the third ribs 52 to press the optical members S.

The third ribs 52 are longitudinal portions of each of the separable supporters 50. The third ribs 52 are connected to the side surfaces of the body 22 of the bottom chassis 20. A connection hole 58 is formed through each of the third ribs 52. Connection protrusions 28 are formed on the outer surface of the body 22 corresponding to the respective connection holes 58 of the third ribs 52. The connection between the separable supporters 50 and the bottom chassis 20 is achieved by inserting the connection protrusions 28 into the connection holes 58.

The fourth rib 56 is a portion of each of the separable supporters 50, which is bent from the third ribs 52 in a horizontal direction. While the second ribs 46 of the integral supporters 40 substantially support the optical members S, the fourth ribs 56 of the separable supporters 50 press the optical members S to prevent the movement of the optical members S. However, the second ribs 46 have a small gap with the optical members S, but the fourth ribs 56 have no gap with the optical members S, and thus press the optical members S.

The position guides 60 are respectively provided at both sides of each of the integral supporters 40. The position guides 60 guide the optical members S to a correct position in the process of connecting the optical members S to the bottom chassis 20. Each of the position guides 60 includes an extension part 64 contacting the first or second optical member edge (S3 or S4 of FIG. 4) in the process of connecting the optical members S to the bottom chassis 20, and a base part 62 protruding from the body 22 and contacting the first or second optical member edge (S3 or S4 of FIG. 4) on a condition that the optical members S have been connected to the bottom chassis 20. The extension part 64 has a cylindrical shape, and the base part 62 is configured such that a portion of the base part 62 contacting the first or second optical member edge (S3 or S4 of FIG. 4) is vertical to a surface of the bottom chassis edge portion 24.

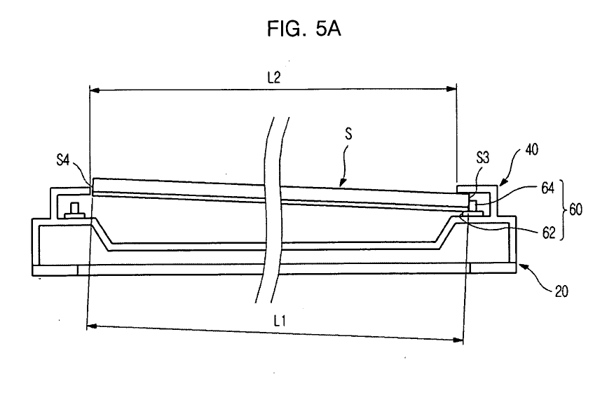

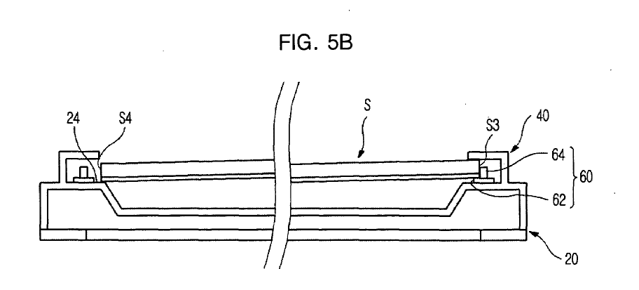

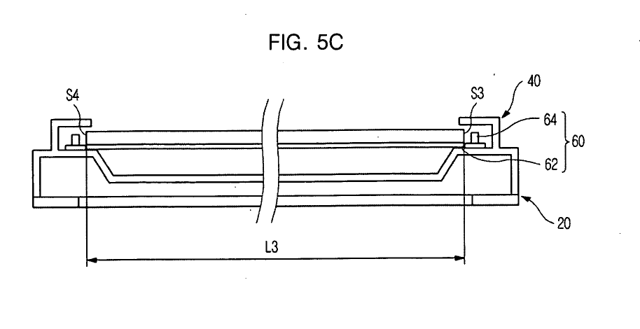

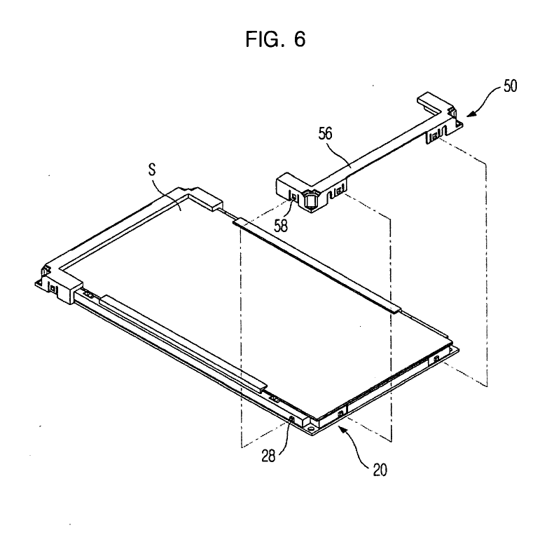

With reference to FIG. 4, FIGS. 5A to 5C, and FIG. 6, a process of connecting the optical members to the above bottom chassis of the display device in accordance with the embodiment illustrated in FIG. 1 will be described, as follows.

FIG. 4 is a perspective view illustrating a connection of the optical members to the bottom chassis of FIG. 1, FIGS. 5A to 5C are side views illustrating a connection of the optical members to the bottom chassis of FIG. 1, and FIG. 6 is a perspective view illustrating a connection of the separable supporters to the bottom chassis.

As illustrated in FIGS. 4 and 5A, the process of connecting the optical members S to the bottom chassis 20 starts with pushing the optical members S obliquely into any one of the integral supporters 40 until the first optical member edge S3 contacts the extension parts 64 of the position guides 60. A width (L1) of the optical members S corresponds to a distance (L2) between the second ribs 46. Thus, when the first optical member edge S3 contacts the extension parts 64 of the position guides 60, the second optical member edge S4 does not contact the other one of the integral supporters 40 provided on the lengthwise side of the bottom chassis 20 being opposed to the integral supporter 40, into which the first optical member edge S3 is inserted.

As illustrated in FIG. 5B, when the optical members S are rotated in a counterclockwise direction on a condition that the first optical member edge S3 contacts the extension parts 64, the second optical member edge S4 contacts the bottom chassis edge portion 24. When the second optical member edge S4 contacts the bottom chassis edge portion 24, the optical members S are pushed in a direction from the first optical member edge S3 to the second optical member edge S4.

As illustrated in FIG. 5C, when a designated force is applied to the optical members S, the first optical member edges S3 contacting the extension parts 64 are lowered to the base parts 62. The distance (L3) between the opposed base parts 62 is equal to the width (L1) of the optical members S. Accordingly, the first and second optical member edges S3 and S4 contact the base parts 62 provided on both lengthwise sides of the bottom chassis 20, and thus the optical members S are guided to the correct position.

As illustrated in FIG. 6, when the optical members S are located at the correct position, the optical members S are fixed to the bottom chassis 20 using the separable supporters 50. The respective separable supporters 50 are connected to the bottom chassis 20 downwardly. Specifically, the separable supporters 50 are connected to the bottom chassis 20 by inserting the connection protrusions 28 formed on the bottom chassis 20 into the connection holes 58 provided on the separable supporters 50. The fourth ribs 56 of the separable supporters 50 press the upper surfaces of the optical members S to prevent the movement of the optical members S.

Hereinafter, with reference to FIGS. 7A to 7B, a reflection suppressing structure of the display device in accordance with the embodiment illustrated in FIG. 1 will be described.

FIGS. 7A and 7B illustrate routes of light emitted from a light source, respectively.

As illustrated in FIG. 7A, in a case that no reflection suppressing structure is formed, light emitted from the light source L is reflected by an inclined tip of the second rib 46. As described above, the bottom chassis 20 is mainly made of PC having an excellent light reflection property, and the integral supporters 40 formed integrally with the bottom chassis 20 also have an excellent light reflection property. Since the light source L is located at a position below the right side from the second rib 46, the light emitted from the light source L is reflected toward the optical members S by the inclined tip of the second rib 46 having an excellent light reflection property. The reflected light is concentrated on a designated position of the optical members S, thus generating a light portion B. The light portion B is lighter than other portions of the optical members S, and thus a difference between light and darkness is generated on the surface of the optical member S. The light portion B of the optical members S causes a designated portion of an image, displayed on the display panel 17, to be lighter than other portions of the image, and thus deteriorates a quality of a display product.

As illustrated in FIG. 7B, in a case that a reflection suppressing structure 70 is formed, a vertical tip of the second rib 46 serves as the reflection suppressing structure 70. When the second rib 46 has the vertical tip, light reflected by the second rib 46 travels toward an inside of the integral supporter 40. Then, the light is repeatedly reflected several times in the integral supporter 40. During the repeated reflection several times, the light is absorbed by the internal structure of the integral supporter 40 and is weakened. Thus, no light portion (B of FIG. 7A) is formed at a designated position of the optical members S, and no difference between light and darkness is generated on the surface of the optical members S.

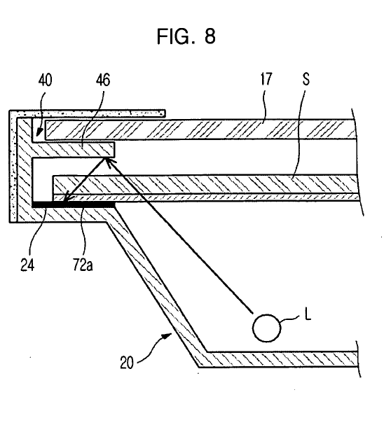

FIG. 8 is a view illustrating a route of light emitted from a light source in a display device in accordance with an embodiment of the present general inventive concept. Some parts in this embodiment, which are substantially the same as those in the first embodiment, are denoted by the same reference numerals even though the respective portions are depicted in different drawings, and some parts in this embodiment, which are modified from those in the embodiment illustrated in FIG. 1, are denoted by reference numerals obtained by adding a suffix ‘a’ to the reference numerals in the embodiment illustrated in FIG. 1.

As illustrated in FIG. 8, the embodiment is the same as the embodiment illustrated in FIG. 1 in that the second rib 46 has a vertical tip. However, in the present embodiment, a light absorption member 72a is provided on the bottom chassis edge portion 24. The light absorption member 72a is obtained by attaching a black tape to the bottom chassis edge portion 24 or coating the bottom chassis edge portion 24 with black. When light reflected by the second rib 46 reaches the light absorption member 72a, the light is absorbed by the light absorption member 72a and thus is not reflected any more. Thus, a possibility that the reflected light is repeatedly reflected and travels to the outside of the integral supporter 40 is highly reduced.

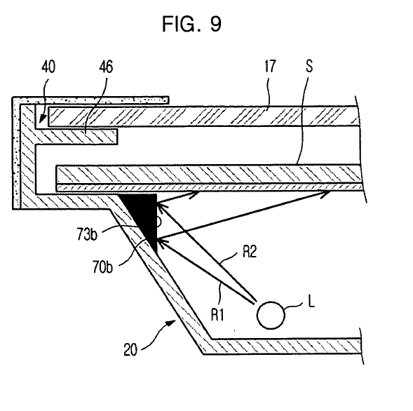

FIG. 9 is a view illustrating a route of light emitted from a light source in a display device in accordance with an embodiment of the present general inventive concept. Some parts in this embodiment, which are substantially the same as those in the first embodiment, are denoted by the same reference numerals even though the respective parts are depicted in different drawings, and some parts in this embodiment, which are modified from those in the embodiment illustrated in FIG. 1, are denoted by reference numerals obtained by adding a suffix ‘b’ to the reference numerals in the embodiment illustrated in FIG. 1.

As illustrated in FIG. 9, a reflection protrusion 70b is provided on the inside of the bottom chassis 20. The reflection protrusion 70b is provided on an entry route of light such that light emitted from a light source L is not incident upon the integral supporter 40. The light is reflected by the reflection protrusion 70b, and travels toward the optical members S. Since a reflection surface 73b of the reflection protrusion 70b is relatively close to the light source L and has a lengthwise length, the light R1 and R2 reflected by the reflection protrusion 70b is not concentrated on a designated portion but is widely dispersed. Thus, no light portion (B of FIG. 7A) is formed at a designated position of the optical members S. Further, a light absorption member (not illustrated) may be attached to the reflection surface 73b such that the incident light is not reflected but is absorbed by the light absorption member.

Although the above embodiments mainly describe a process of connecting optical members to a bottom chassis by pushing optical members obliquely into integral supporters, the optical members may be connected to the bottom chassis by sliding the optical members from a side surface of the bottom chassis to an inside of the integral supporters.

Further, although the above embodiments describe a reflection suppressing structure provided on integral supporters, the reflection suppressing structure may be provided on separable supporters as well as the integral supporters.

As apparent from the above description, various embodiments of the present general inventive concept provides a display device, which includes separable supporters having a smaller size than that of a conventional middle bezel to reduce production costs and to easily assemble optical members to a bottom chassis, and a bottom chassis thereof.

A display device of the present general inventive concept and a bottom chassis thereof prevent a difference between light and darkness on optical members due to lightening only specific portions of optical members by light reflected by an optical member fixing unit.

The bottom chassis of an embodiment of the present general inventive concept has excellent physical characteristics, such as a thermal expansion rate, strength, and a injection molding property.

Although various embodiments of the present general inventive concept have been illustrated and described, it would be appreciated by those skilled in the art that changes may be made in these embodiments without departing from the principles and spirit of the general inventive concept, the scope of which is defined in the claims and their equivalents.

What is claimed is:

1. A display device, which has a bottom chassis provided with an opening formed at one side thereof and receiving light sources therein, and at least one optical member connected to the opening to enhance optical characteristics of light emitted from the light sources, comprising an optical member fixing unit comprising:
integral supporters formed integrally with the bottom chassis; and
separable supporters connected to the bottom chassis to prevent movement of the at least one optical member connected to the integral supporters.

2. The display device according to claim 1, wherein the optical member fixing unit further comprises:
position guides protruding from the bottom chassis to guide the at least one optical member to a correct position.

3. The display device according to claim 2, wherein each of the position guides includes:
a base part contacting an edge of the at least one optical member on a condition that the at least one optical member has been connected to the bottom chassis; and
an extension part extended from the base part.

4. The display device according to claim 2, wherein the position guides are provided at both ends of each of the integral supporters.

5. The display device according to claim 1, wherein:
the integral supporters are provided on at least one edge of the bottom chassis; and
each of the integral supporters includes a first rib protruding along the at least one edge to a height of an overall thickness or more of the at least one optical member, and a second rib bent from the first rib toward an inside of the bottom chassis.

6. The display device according to claim 1, wherein:
the separable supporters are connected to the bottom chassis such that the separable supporters cannot interfere with the integral supporters; and
each of the separable supporters includes third ribs connected to the bottom chassis and a fourth rib bent from ends of the third ribs to press the at least one optical member.

7. The display device according to claim 6, wherein:
at least one connection protrusion is provided on the bottom chassis; and
a connection hole, into which the at least one connection protrusion is inserted, is formed on the third ribs.

8. The display device according to claim 1, wherein the optical member fixing unit comprises:
a reflection suppressing structure to prevent a difference between light and darkness generated on the at least one optical member due to reflection of the light.

9. The display device according to claim 8, wherein the reflection suppressing structure comprises:
a reflection angle changing part to change a refraction direction of the light to reflect the light, being incident toward the optical member fixing unit, toward an inside of the optical member fixing unit.

10. The display device according to claim 8, wherein the reflection suppressing structure comprises:
a light absorption member to absorb the light being incident toward an inside of the optical member fixing unit.

11. The display device according to claim 8, wherein the reflection suppressing structure comprises:
a reflection protrusion to reflect the light such that the light cannot be incident toward an inside of the optical member fixing unit.

12. A display device, comprising:
a bottom chassis provided with an opening formed at one side thereof, to receive light sources therein, and made of a light reflective material to guide light emitted from the light sources toward the opening;
at least one optical member connected to the opening to enhance optical characteristics of the light emitted from the light sources; and
an optical member fixing unit comprising integral supporters formed integrally with the bottom chassis, and separable supporters connected to the bottom chassis to prevent movement of the at least one optical member connected to the integral supporters.

13. The display device according to claim 12, wherein the light reflective material is polycarbonate (PC) containing 10˜30% of glass fiber.

14. The display device according to claim 12, wherein the optical member fixing unit further comprises:
position guides protruding from the bottom chassis to guide the at least one optical member to a correct position.

15. The display device according to claim 12, wherein the optical member fixing unit comprises:
a reflection suppressing structure to prevent a difference between light and darkness generated on the at least one optical member due to reflection of the light.

16. A display device, comprising:
a bottom chassis including integral supporters disposed at edge portions thereof to receive optical members therein; and
separable supporters connectable to opposite sides of the bottom chassis to support the optical members to be fixed to the bottom chassis.

17. The display device according to claim 16, wherein the optical members include a light converging sheet and a diffusion plate.

18. The display device according to claim 16, wherein the separable supporters include a first set of ribs and a second set of ribs extending in an outward direction from the first set of ribs.

19. The display device according to claim 16, wherein the integral supporters comprise:
position guides to guide the optical members; and
ribs having a distance therebetween,
wherein a width of the optical members and the distance between the ribs are different.
